(19) United States
(12) Patent Application Publication
(10) Pub. No.: US 2004/0122950 A1
(43) Pub. Date: Jun. 24, 2004

(54) Method for managing workloads in an autonomic computer system for improved performance

(76) Inventors: Stephen Paul Morgan, San Jose, CA (US); Edward Gustav Chron, Sunnyvale, CA (US); Lance Warren Russell, Hollister, CA (US)

Correspondence Address: KHANH Q. TRAN, IBM CORPORATION, INTELLECTUAL PROPERTY LAW, 650 HARRY ROAD, DEPT. C4TA/J2B, San Jose, CA, 95120-6099, US

(21) Appl. No.: 10/327,337

(22) Filed: Dec. 20, 2002

(51) Int. Cl. G06F 15/173

(52) U.S. Cl. 709/226

(57) ABSTRACT

A method and system for managing workloads in an autonomic computer system based on feedback and feed-forward performance information. The method establishes a performance objective for the system, determines a measure of instantaneous demand in the system, continuously tracks the objective with respect to the measure, forecast a future demand based on an autoregressive time series of the system, and adjusts the control parameters of the system to meet the objective. The performance objective is associated with a confidence level and typically includes a desired system response time. The tracking step includes obtaining performance data on the system and storing the performance data in a persistent data store. The demand forecasting uses a Spectral Forecasting procedure to forecast a future workload from a present workload.

### TECHNICAL FIELD

The invention generally relates to computer systems that service multiple workloads, and more particularly to a method for managing workloads in an autonomic computer system to improve system performance.

### BACKGROUND OF THE INVENTION

Large computing systems, especially those running time-varying workloads, are difficult to keep tuned. System parameters need to be adjusted in to response to changing workloads so that optimal performance for the system can always be achieved. As a result, dozens of interacting parameters may need to be understood and properly adjusted. Even if a system is tuned well at one point, due to the changing workloads, it may end up being poor tuned at some other point. Poorly tuned systems not only degrade system performance, they also waste resources, and frustrate users. There is substantial and growing interest in autonomic systems, i.e., systems that dynamically self-regulate. A key aspect of self-regulation is self-tuning.

Current work on autonomic tuning is only slightly more advanced than static tuning. Such work mainly revolves around primitive notions of reactive autonomicity, based on conventional feedback control principles. Reactive autonomic systems reconfigure themselves based on instantaneous need or, at best, based on short-term historical measurements. As with any techniques involving feedback control, reactive autonomic systems have the well-known problems of potential instability or slow response to change.

Examples of computer storage systems that use reactive autonomicity for self-tuning or error-recovery based on event recognition are the Tivoli Storage Resource Manager provided by IBM Corporation and the AF/Operator provided by Candle Corporation. Many other computer products use feedback systems that monitor events and react in an automated fashion when certain conditions are met.

U.S. Pat. No. 5,537,542 describes an apparatus and method for managing a server workload according to client performance goals. It provides a workload manager that keeps track of a set of performance goals where each goal is associated with a class of client transactions. A set of servers in the system analyzes the performance of the class, the performance goals and the resources affecting the class performance. Changes are then made to the allocation of resources as needed to improve the performance of the class. The method provides an object-oriented client/server workload management that is determined at the client's system. This method is applicable to client-server workload management applications, and requires the choice of a server to be made at the client and is a policy-based management scheme. It does not rely on feedback or feed-forward and does not discuss prediction or any specific methodology for achieving any kind of performance goals.

U.S. Pat. No. 6,014,700 discloses a method for managing workloads in a client-server network based on a workload management policy that is determined at the client's system. A server in the network is chosen to satisfy a client request based on a workload management policy. The method forms an extended object reference based on the request and accesses a workload management policy using the extended object reference. One of the servers is selected to handle the request according to the workload management policy. This method is applicable to client-server workload management applications, requires the choice of a server to be made at the client and their performance prediction is based on current demand and achievable demand but not predicted demand. Also, the system requires that model be specified manually where as the present invention automatically generates a model from time series analysis of the observed activity.

PCT patent application Ser. No. WO0239279A2 describes an I/O resource management system based on modeled and monitored I/O resource information. The system dynamically adjusts information management system I/O operational parameters to meet changing requirements or demands of a dynamic application using a resource-management architecture. The I/O resource management system includes a resource manager, a resource model, a storage device workload monitor and a storage device. The focus of the disclosed invention is to manage the use of I/O resources rather than to predict and optimize a system based on objective.

Therefore, there remains a need for a method and autonomic computer system for continuously managing workloads based on feedback and feed-forward performance information without the above-described drawbacks.

### SUMMARY OF THE INVENTION

It is an object of the present invention to provide a method and system for optimizing the performance of a computer system based on feedback mechanisms.

It is another object of the present invention to provide a method and system for optimizing the performance of the computer system based on feed-forward mechanisms.

It is still another object of the invention to provide a method and system for optimizing the performance based on a combination of the feedback and feed-forward mechanisms in such a way that the feedback and feed-forward optimizations are complimentary to each other.

It is yet another object of the invention to provide a method and system to ensure that the mechanisms provided to optimize the performance are simple to implement for a variety of workloads and environments.

It is a further object of the invention to provide a system and method to ensure that the mechanisms provided to optimize performance are applicable to a virtual system comprising individual systems, where the properties and capabilities of the individual systems may be significantly disparate.

It is a yet further objective of the invention to provide a system and method for optimizing the performance by automatically generates a model that is used to estimate performance from demand to meet the performance objective.

To achieve these and other objects, the present invention provides a method for managing workloads in an autonomic computer system based on feedback and feed-forward performance information. The method establishes a performance objective for the system, determines a measure of instantaneous demand in the system, continuously tracks the performance objective with respect to the measure, forecast a future demand based on an autoregressive time series of the system, and adjusts the control parameters of the system to meet the objective. The performance objective is associated with a confidence level and typically includes a desired system response time. The tracking step includes obtaining performance data on the system and storing the performance data in a persistent data store. The demand forecasting uses a Spectral Forecasting procedure to forecast a future workload from a present workload.

The autonomic computer system services a plurality of clients and has a set of control parameters that can be adjusted to affect the performance of the system. The system includes an autonomic controller that establishes a performance objective for the system, determines a measure of instantaneous demand in the system, tracks the objective with respect to the measure, forecast a future demand based on an autoregressive time series of the system, and adjusts the control parameters to meet the system performance objective.

Another preferred embodiment of the invention for a Network Attached Storage (NAS) system is also described. The autonomic NAS system includes files that are accessed by clients through data requests, data stores for processing the data requests from the clients, and a request router for distributing the data requests among the data stores. There are a number of parameters that control the performance of the system and can be adjusted. The management operations are performed by an autonomic controller that tracks the number of data requests with respect to a performance objective and adjusts the parameters to satisfy the performance objective.

Additional objects and advantages of the present invention will be set forth in the description which follows, and in part will be obvious from the description and with the accompanying drawing, or may be learned from the practice of this invention.

### BRIEF DESCRIPTION OF THE DRAWING

FIG. 1 is a flow chart showing the general process of managing workloads in an autonomic computer system in accordance with the invention.

FIG. 2 is a flow chart showing a preferred process for forecasting future workload demand in the autonomic system in accordance with the invention.

FIG. 3 is a block diagram showing the general configuration of an autonomic Network Attached Storage (NAS) system in accordance with the invention.

FIG. 4 is a flow chart showing a preferred process for adjusting controllable parameters of the autonomic NAS system in accordance with the invention.

FIG. 5 is a chart showing the improved performance of the autonomic NAS system of the invention.

### DESCRIPTION OF THE PREFERRED EMBODIMENTS

The invention will be described primarily as a method and system for managing workloads in an autonomic computer system. However, persons skilled in the art will recognize that an apparatus, such as a data processing system, including a CPU, memory, I/O, program storage, a connecting bus, and other appropriate components, could be programmed or otherwise designed to facilitate the practice of the method of the invention. Such a system would include appropriate program means for executing the operations of the invention.

Also, an article of manufacture, such as a pre-recorded disk or other similar computer program product, for use with a data processing system, could include a storage medium and program means recorded thereon for directing the data processing system to facilitate the practice of the method of the invention. Such apparatus and articles of manufacture also fall within the spirit and scope of the invention.

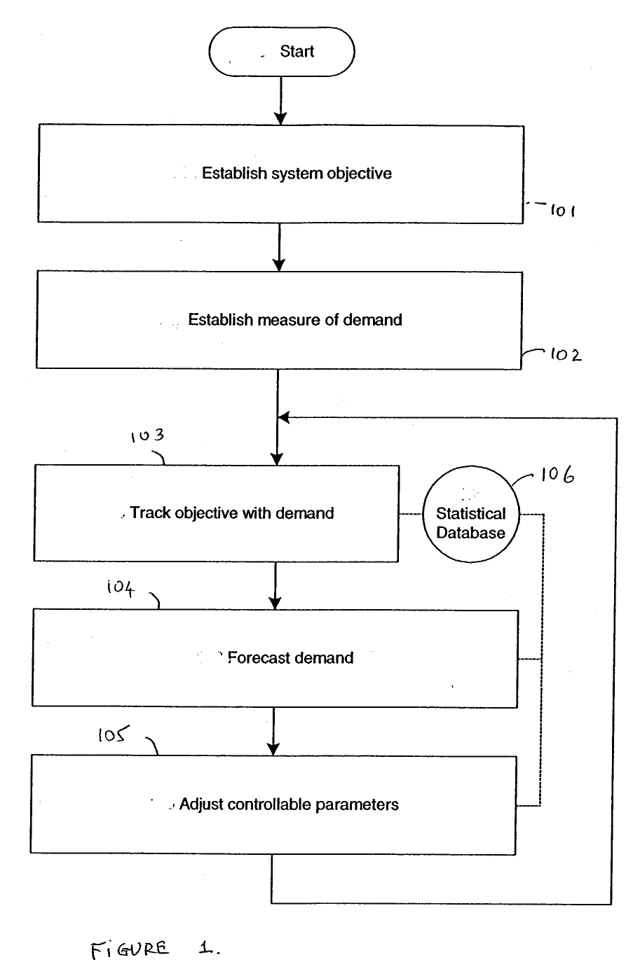

FIG. 1 is a flowchart showing the general method of the invention. Steps 101-102 are configuration steps while steps 103-106 are operational steps. At step 101, the method establishes a quantifiable system objective. In the preferred embodiment of the invention, the system objective comprises a performance objective and a confidence level. A typical performance objective for a computer system might be a target number of transactions that the system can perform in a certain time window. For a storage system, the objective might be a target number of requests or an average response time for a file class or client class. For a network system, the objective might be the number of network transactions that the system can handle in a time period.

The system objective may have several subclasses. For example, some clients of the autonomic computer system may be willing to trade increased response time for lower cost. The objective thus can be different for each class of clients.

The confidence level measures how closely the system must meet its performance objective. For example, the computer system might need to achieve the average response time 66% of the time. Thus, the confidence level would be 66% in this case.

At step 102, a measure of instantaneous demand in the system is established such that the measure can be used to track the system objective. In the autonomic computer system of the invention, a measure of instantaneous demand might be the number of requests, for example, for a file class or client class, that the system can currently process. Depending on the nature of the system, more than one measure might be established in step 102. For example, one measure might be the number of operations completed for a file while a second measure indicates the number of operations completed by a storage node.

In steps 103 through 105, the method of the invention continually tracks, forecasts, and adjusts the operation of the system to meet the objective. At step 103, the method tracks the system performance in relation to the instantaneous demand. In the preferred embodiment of the invention, the method also stores system performance data over time in a persistent store, such as a statistical database. In a storage system, the method would track the average response time as requests were being processed by the system.

At step 104, future workload demand in the system is forecast, along with uncertainty, using an autoregressive time series. The autoregressive time series analysis projects future values of a variable based on the history of that variable alone, which simplifies forecasting considerably. A time series is viewed as an infinite moving average. Applying a Spectral Forecasting method transforms the time series from the time domain to the frequency domain, which can then be used to generate forecasts. The method applies Autoregressive Integrated Moving Average (ARIMA) to the data in the persistent store to obtain the demand forecast. The data series application and Spectral Forecasting can be automated. The Autoregressive Integrated Moving Average (ARIMA) model is described, for example, by G. Box et al. in the text book “Time Series Analysis, Forecasting and Control,” Third Edition, Prentice Hall, 1994 (hereafter, Box et al.).

At step 105, the system's controllable parameters are adjusted to meet the system objective in anticipation of the forecast demand. The forecast is used as the basis to adjust the system controllable parameters. For example, in a data storage system, the method preferably would reassign files to data stores, replicate files among or migrate files between the data stores, or would bring the data stores on-line or off-line to meet the forecast demand. The tracking data, demand forecast, and controllable parameters are preferably maintained in a statistical database 106.

General computer systems can have a variety of control parameters that may be adjusted. For example, the parameters are for controlling or limiting the mix of workloads that a system is asked to process, for favoring certain work requests over other work requests, for making system resources available or unavailable, or for dedicating resources to certain work requests and spreading load across multiple systems. Data storage systems and network systems have similar types of controls, i.e., those for limiting the number of requests a system is asked to process, favoring certain requests over other requests, adding or removing resources to handle load, or dedicating resources to certain requests and spreading load across multiple systems.

Since the controls for these systems are similar to each other, the methods that use these controls to optimize performance from demand to meet an objective are also similar. The key difference among the three system types is that the objective and confidence level will be different and the variables measured for demand will then be different but the method used to estimate performance from demand to meet an objective for each of the systems can be the same.

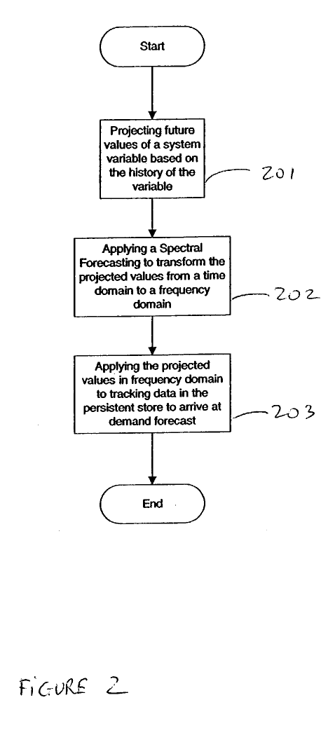

FIG. 2 is a flow chart showing a preferred process for forecasting future workload demand in the autonomic system in accordance with the invention. At step 201, future values of a system variable are projected based on the history of the variable. At step 202, a Spectral Forecasting is applied to transform the projected values from a time domain into a frequency domain. At step 203, the projected values in the frequency domain are applied to tracking data in the persistent store to arrive at demand forecast.

To better illustrate the operations in the above-described method, a preferred embodiment of the invention for a Network Attached Storage (NAS) system is now described. The operations of the invention allow the system to be a scalable, autonomically tuned NAS system. With the system environment being a shared-disk environment, file reassignment is described, but not file replication or migration. In a serially-shared disk or a shared-nothing environment, the implementation would typically include file replication and migration. In such environments, the present invention would perform even better when compared with feedback-based control methods, as the latter cannot dynamically replicate or migrate files, in advance of need.

Network Attached Storage

A Network Attached Storage (NAS) system is a network file server that processes requests sent to it via protocols such as the Network File System (NFS), over a medium such as Ethernet, by one or more clients. NFS, layered in turn on the TCP/IP communications protocol suite, uses a remote procedure call architecture, where every request from a client to a server engenders a response from the server to the client. Typical NFS requests are to create a file, to write data to a file, to read data from a file, and to delete a file. A response indicates whether the corresponding request was processed without error and, if so, contains request-specific data, e.g., file contents from a read.

A NAS acts as a central repository for data shared among clients. With a NAS, the clients need not store the data individually, reducing cost. The clients also need not coordinate updates to the data, simplifying their workings. Data management may be centralized, simplifying management and reducing costs. Small computers may be deployed widely; alternatively, large systems may be scaled further. It is desirable to have a powerful NAS, to support more clients or to process more work from the same number of clients. In this specification, the NAS system is a scalable architecture that integrates multiple data stores into a single, virtual NAS. Requests are sent to the virtual NAS, and are spread among the individual stores. The advantage of the architecture is that systems of various capabilities, including a very powerful system, may be built from relatively inexpensive components. The disadvantage is that a system's overall performance will be only as good as that of its worst performing data store. A virtual NAS could be massively over provisioned to minimize the effect of one poorly performing data store, but that would reduce the architecture's advantage. Alternatively, autonomic tuning could be used to balance workloads among the data stores. The latter approach was chosen for the preferred embodiment.

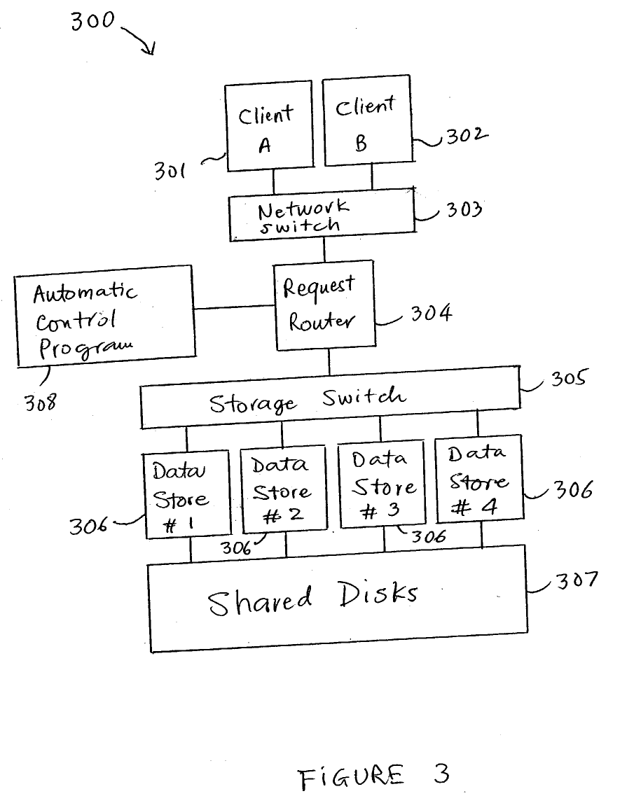

FIG. 3 is a block diagram of an autonomic Network Attached Storage (NAS) system 300 according to the invention. The NAS system 300 includes two representative clients 301-302. The clients 301-302 are connected to a request router 304 through a network switch 303. The request router 304 is attached to data stores (or servers) 306 through a storage switch 305. The data stores 306 in turn access data on shared disks 307. The data stores 306 process requests for files kept in a cluster file system maintained in the system 300. The request router 304 spreads the requests among the data stores 306. An autonomic control program 308 directs the request router 304, following the method of the invention as described above. The overall storage system 300 is referred to as “NAS plex”, as it integrates multiple, otherwise independent systems.

The clients 301-302, the request router 304, and the data stores 306 are computers. Although the clients 301-302 are configured identically, the data stores 306 deliberately are not, so that the original un-managed NAS system (without the embodiment of the method of the invention) is inherently unbalanced. The data stores 306 contain processors of various speeds. Some data stores 306 have one processor, while other data stores might have more than one processor. The data stores 306 might have different amounts of memory.

The autonomic NAS system 300 works as follows. A client 301 sends a request to the request router 304, which forwards it to one of the data stores 306 for processing. Any data store 306 may access any file, as files are managed by a cluster file system (in the NAS system 300), which coordinates accesses to them. Which data store 306 will process a given request is a decision made by method of the invention based on the type of the request, the file to which it refers, and the system's state. The decision process is described in more detail below.

The operations of the invention enable the NAS system 300's load to be shared among its data stores 306. Load balancing, or intelligently sharing load, has two main benefits. First, as with any modern computer system, performance is nonlinear. Past a saturation point, a linear increase in load causes a much greater increase in response time. Balancing load can keep the NAS system 300 operating within a linear performance region. Second, assigning related requests to the same data store 306 can take advantage of data caching, thereby keeping the number of I/Os, and the amount of computation, low.

In the NAS system 300, workloads could be balanced statically, that is, files could be assigned to the data stores 306 following a fixed schedule, or it could be balanced dynamically, with file assignment changing over time. In reality, static assignment would prove a poor choice. Requests arriving clustered in time tend to be related, load tends to include multiple cyclical components, and load tends to vary substantially over time. The NAS system 300 is dynamically balanced using feed-forward control.

The request router 304 is aware of requests from a Network File System (NFS) and its response. The request router 304 analyzes and routes requests and responses at network speeds. The request router 304 records statistics on a per-file, per-request basis, as well as on a per-server, per-response basis. It forwards requests to appropriate stores using a default rule and an exception set.

The autonomic NAS system 300 of the invention uses a simple hash of the NFS file handle (or file identifier) to choose a data store 306 to handle an incoming request. This is used as the default rule too chose a data store 306. The default rule has several characteristics: it spreads load more or less uniformly among the data stores 306, it repeatedly assigns a given file to the same data store 306, and it is simple to compute. Given these characteristics, the NAS system 300 takes advantage of store data (and cluster file system token) caching; however, it assigns files to the data stores 306 statically, ignoring store load and file heat, i.e., the extent to which the file contributes to load.

Using the statistical data gathered by the request router 304, the method of the invention performs the following operations periodically:

It tracks and forecasts the data stores' response time at a given load.

It tracks and projects per-file heat.

It estimates the effect on response time of reassigning hot files to the data stores 306; decides which file to reassign, and updates the router's exception set, to actually reassign the files.

Assuming there are cyclical components to access patterns, the NAS system 300 makes projections and assignments that are refined over time, as its statistical database grows. The combination of feedback and feed-forward allows the invention to detect and adjust assignments rapidly if there is a fundamental change in access patterns.

The NAS system 300 of the invention projects the expected workload of each file using time series analysis methods similar to those used in the field of econometrics. In particular, the system 300 models workload using an Autoregressive Integrated Moving Average (ARIMA) model, as described by Box et al., from which it extracts cyclical components. The NAS system 300 applies a Spectral Forecasting procedure to the components, to forecast a future workload from a present workload. The Spectral Forecasting procedure is described by J. Geweke in “Priors For Macroeconomic Time Series and Their Applications,” Discussion Paper No. 64, Federal Reserve Bank of Minneapolis, Institute for Empirical Macroeconomics, 1992. In essence, the number of requests per period is viewed as an infinite moving average, a Fourier transform of the time series is estimated, a corresponding time-domain model is computed, and the model is used to forecast load. As the same model applies to all such series, the procedure can be automated.

Using the load forecast, the NAS system 300 of the invention determines which data stores 306, if any, are likely to be overloaded in the next period. It iteratively proposes a reassignment of files from overloaded data stores 306. Files are proposed for reassignment in descending order of heat, i.e., the frequency of access. The iteration terminates when the NAS system's performance objective is achieved or, if the objective cannot be achieved due to system overload, when the workload in the NAS system 300 is balanced.

Given a proposed assignment, the NAS system 300 estimates a data store 306's response time using a spectral procedure for estimating Generalized Least Squares. An example of the spectral procedure is described by E. J. Hannan in “Time Series Analysis,” pages 17-37, Wiley, 1963. This procedure is applicable assuming that all factors taken together, other than the number of requests processed in a period, follow a stationary ARIMA process. In practice, this assumption has proven reasonable. As the same model applies to all data series, the procedure again can be automated.

Rather than using a default rule and iteratively proposing reassignment of a few hot files, the NAS system 300 could have computed an optimal assignment following a stochastic optimization model. This procedure requires historical data on load and response time, which the request router 304 gathers and records. In reality, such a computation would be highly complex and slow. Given the existence of a simple default rule, the invention has an adequate starting point from which to iteratively apply incremental changes, which quickly leads to good results. There is no need to apply a more complex procedure.

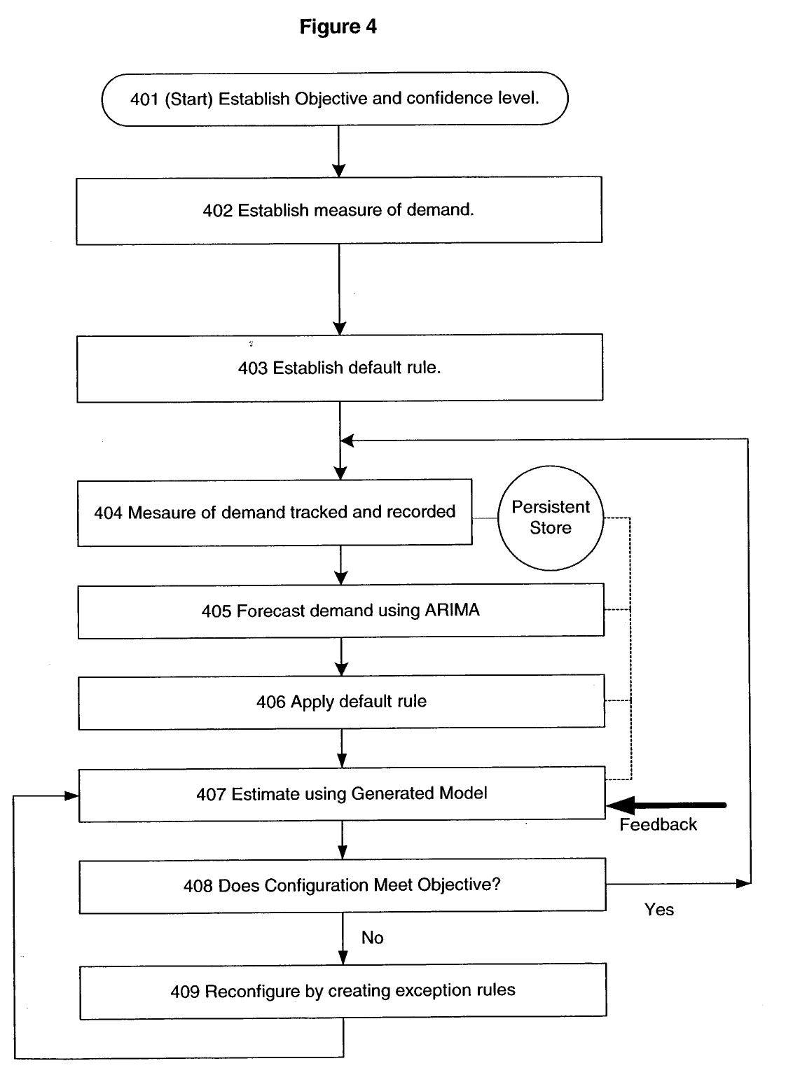

FIG. 4 is a flow chart showing a preferred process for adjusting controllable parameters of the autonomic NAS system 300 in accordance with the invention. At step 401, a performance objective is established that includes a measurable performance goal and a confidence level for achieving that goal. For a NAS system, for example, the measurable goal can be to minimize request response time such that a request is processed and returned to the requestor within 10 milliseconds 90% of the time.

At step 402, a measure of demand is established for one or more system variables. For a NAS system, for example, the measure of demand can be the tracking of the number, type and size of requests for a given file and to which data store 306 a request was routed to and how long it took to complete the request.

At step 403, a default rule is established that statically reconfigures the NAS system by providing a default action or configuration. For a NAS system, for example, the default rule might be to route the requests to different data stores 306 based on their file identification. For example, all requests for a file will go to the data store #1 while the requests for another file will go to the data store #2 in FIG. 3.

At step 404, the measure of demand is tracked and recorded as data that is maintained in a persistent store. The NAS system in the example tracks the number and size of requests routed for a certain file to a specific data store along with how long the requests took to complete and stores the tracking data chronologically in a persistent store.

At step 405, the method forecasts a future demand using an autoregressive time series. A time series is viewed as an infinite moving average of a value. By applying a spectral forecasting technique, the time series is transformed from the time domain to the frequency domain, which can then be used to generate forecasts. The described method is applicable to all data series which can be automated. The method applies the Autoregressive Integrated Moving Average (ARIMA) to data in the persistent store to obtain the demand forecast.

At step 406, the default rule is applied to each request to produce a projection of how the requests will be routed. For a NAS system, for example, the model is used to determine how requests will be distributed among the data stores.

At step 407, the system performance is estimated using the generated model, taking into consideration any feedback that the method determines is relevant. Demand is used as input to the model to determine the system performance. For a NAS system, for example, the requests for files over a time interval are used as input to determine the system performance including any adjustment made due to feedback, where feedback would be file request activity that deviates from the forecast demand. The rate could be different for a file or the distribution of requests to be different files than forecast etc.

At step 408, the method estimates, given the projection, whether in its current configuration the system will meet the objective within the desried confidence level. For a NAS system, for example, the result of the model's distribution of requests is used to predict whether the system configuration is expected to meet the objective within the confidence level.

At step 409, if the projection estimates that the current configuration will not meet the objective then the method reconfigures the system to attempt to meet the objective. For a NAS system, for example, exception rules (rules that override the default rule in specific instances) can be generated to redistribute requests. An example is that all requests for file 28 should go to data store #2, not data store #1 as the default rule dictates.

To evaluate the performance of the autonomic NAS system 300, four actual workloads from real systems were used. All four workloads were issuing requests for data at a heavy rate. The NAS system 300's response time was changing non linearly as a function of its load. The NAS system 300 was evaluated with the workloads running simultaneously and independently. First, the workloads were run with file reassignment disabled, and again with it enabled. The results given below correspond to a representative 24-hours of the trace, starting 622 hours into it, though there is no significance to this particular choice of starting period. Each period corresponds to one hour of the trace.

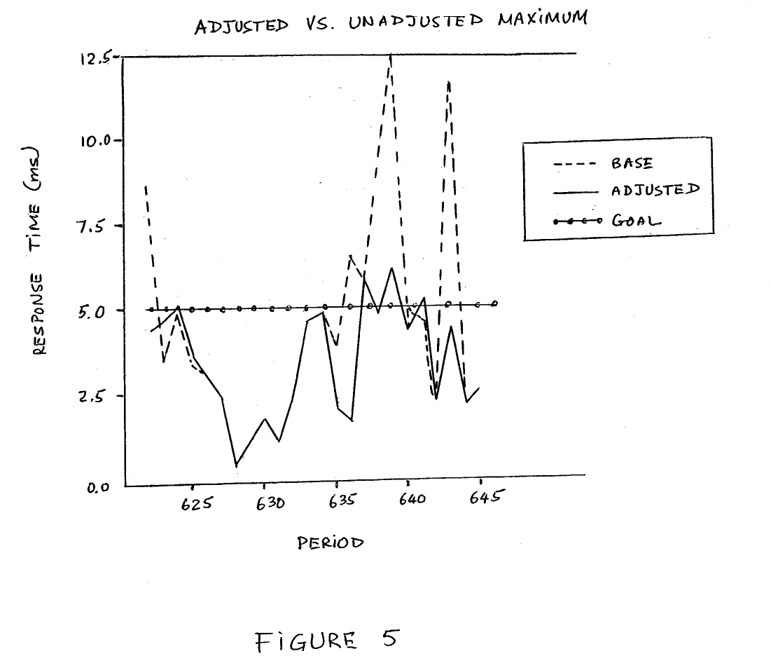

FIG. 5 is a chart showing the effect of the file reassignments on response time in a NAS system using the invention. The graph shows the maximum of the average per-store response time. “Base” indicates the measured times without reassignment, while “Adjusted” indicates the times with reassignment. The NAS system 300 achieved the performance component of its goal, or came very close, in nearly all periods. It missed by more than calibration error only in periods 637 and 639. Given the confidence level chosen, it achieved its overall goal. It is notable that, during Periods 639 and 643, including one of the periods in which it missed its performance goal, the invention reduces the system's maximum average response time nearly in half.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

What is claimed is:

1. A method for managing workloads in a computer system having a plurality of control parameters, the method comprising the steps of:
establishing a performance objective for the system;
determining a measure of instantaneous demand in the system;
tracking the objective with respect to the measure;
forecasting a future demand based on an autoregressive time series of the system; and
adjusting the control parameters of the system to meet the objective.

2. The method as recited in claim 1, wherein the performance objective is associated with a confidence level.

3. The method as recited in claim 1, wherein the performance objective comprises a system response time.

4. The method as recited in claim 1, wherein the measure includes how many transactions the system can handle in a time period.

5. The method as recited in claim 1, wherein the measure includes how many data requests the system can service in a time period.

6. The method as recited in claim 1, wherein the step of tracking includes the steps of:
obtaining performance data on the system; and
storing the performance data in a persistent data store.

7. The method as recited in claim 1, wherein the step of forecasting is based on an Autoregressive Integrated Moving Average (ARIMA) model.

8. The method as recited in claim 7, wherein the step of forecasting includes a Spectral Forecasting procedure to forecast a future workload from a present workload.

9. The method as recited in claim 1, wherein the step of adjusting is based on the forecast demand and an estimated effect of the forecast demand on the system.

10. The method as recited in claim 9, wherein the effect is estimated using a Generalized Least Squares procedure.

11. The method as recited in claim 10, wherein the parameters are adjusted in response to the estimated effect on the system.

12. The method as recited in claim 11, wherein the step of adjusting is further based on a feedback of a current demand on the system.

13. A method for managing workloads in a computer storage system having a plurality of control parameters and data, the data accessed by clients through requests for data, the method comprising the steps of:
establishing a performance objective for the system;
determining a measure of instantaneous demand in the system based on the number of the requests being processed by the system;
tracking the objective with respect to the measure;
forecasting a future demand based on an autoregressive time series of the system; and
adjusting the control parameters of the system to meet the objective.

14. An autonomic computer system comprising:
a plurality of clients accessing the system;
a plurality of parameters controlling the performance of the system; and
an autonomic controller for establishing a performance objective for the system, determining a measure of instantaneous demand in the system, tracking the objective with respect to the measure, forecasting a future demand based on an autoregressive time series of the system, and adjusting the control parameters of the system to meet the objective.

15. An autonomic computer storage system comprising:
a plurality of parameters for controlling the performance of the system;
a plurality of data files accessed by clients through data requests;
a plurality of data stores for processing the data requests from the clients;
a request router for distributing the data requests among the data stores; and
an autonomic controller for establishing a target request-processing objective, determining a measure of instantaneously processed requests, tracking the objective with respect to the measure, forecasting a future demand based on an autoregressive time series of the system, and adjusting the parameters to satisfy the performance objective.

16. A computer-program product for use with a computer system for managing workloads in the system, the system having a plurality of control parameters, the computer-program product comprising:
a computer-readable medium;
means, provided on the computer-readable medium, for establishing a performance objective for the system;
means, provided on the computer-readable medium, for determining a measure of instantaneous demand in the system;
means, provided on the computer-readable medium, for tracking the objective with respect to the measure;
means, provided on the computer-readable medium, for forecasting a future demand based on an autoregressive time series of the system; and
means, provided on the computer-readable medium, for adjusting the control parameters of the system to meet the objective.

17. A computer-program product for use with a computer storage system for managing workloads in the system, the system accessed by data requests and having a plurality of control parameters, the computer-program product comprising:
a computer-readable medium;
means, provided on the computer-readable medium, for establishing a target request-processing objective
means, provided on the computer-readable medium, for determining a measure of instantaneously processed requests;
means, provided on the computer-readable medium, for tracking the objective with respect to the measure;
means, provided on the computer-readable medium, for forecasting a future demand based on an autoregressive time series of the system; and
means, provided on the computer-readable medium, for adjusting the control parameters of the system to meet the objective.
